(19) United States
(12) Patent Application Publication
(10) Pub. No.: US 2025/0223167 A1
(43) Pub. Date: Jul. 10, 2025

(54) LOW-DEFECT CARBON NANOTUBE SLUDGE AND PREPARATION METHOD THEREFOR, CONDUCTIVE COMPOSITE MATERIAL BASED ON THE LOW-DEFECT CARBON NANOTUBE, NEGATIVE ELECTRODE SLURRY USING SAME, NEGATIVE ELECTRODE, AND LITHIUM SECONDARY BATTERY

(71) Applicant: KOREA ELECTROTECHNOLOGY RESEARCH INSTITUTE, Gyeongsangnam-do (KR)

(72) Inventors: Seon Hee SEO, Gyeongsangnam-do (KR); Geon Woong LEE, Gyeongsangnam-do (KR); Seung Yol JEONG, Gyeongsangnam-do (KR); Hee Jin JEONG, Gyeongsangnam-do (KR); Sun Hye YANG, Gyeongsangnam-do (KR); Ick Jun KIM, Gyeongsangnam-do (KR); Jung Mo KIM, Gyeongsangnam-do (KR); See Un KIM, Gyeongsangnam-do (KR)

(73) Assignee: KOREA ELECTROTECHNOLOGY RESEARCH INSTITUTE, Gyeongsangnam-do (KR)

(21) Appl. No.: 18/699,583

(22) PCT Filed: Aug. 30, 2022
(86) PCT No.: PCT/KR2022/012942

§ 371 Date: Apr. 8, 2024

(30) Foreign Application Priority Data
Oct. 19, 2021 (KR) 10-2021-0139648
Jul. 7, 2022 (KR) 10-2022-0083667

(51) Int. Cl. C01B 32/174; H01M 10/052

(52) U.S. Cl. CPC C01B 32/174; H01M 10/052; C01B 2202/02; C01B 2202/06; C01B 2202/22; C01B 2202/34; C01P 2002/82; C01P 2004/02; C01P 2004/03; C01P 2006/40

(57) ABSTRACT

The present invention relates to a low-defect carbon nanotube sludge and a preparation method therefor, a conductive composite material based on the low-defect carbon nanotube, a negative electrode slurry using same, a negative electrode, and a lithium secondary battery, and has the technical gist of comprising carbon nanotubes that have crystallinity while satisfying relational expression 1 below. [relational expression 1] 5≤I_{G}/I_{D}≤50 (wherein I_{G}/I_{D} is a value calculated as a ratio of a maximum peak intensity (I_{G}) measured at 1,580±50 cm⁻¹ to a maximum peak intensity (I_{D}) measured at 1,360±50 cm⁻¹ in a wavenumber region of a Raman spectrum.)

### TECHNICAL FIELD

The present disclosure relates to a low-defect carbon nanotube sludge and a preparation method thereof, a conductive composite material based on low-defect carbon nanotubes, a negative electrode slurry using the same, a negative electrode, and a lithium secondary battery.

### BACKGROUND ART

A carbon nanotube, discovered by Sumio Iijima in 1991, has a cylindrically rolled tube-like form with a repeating hexagonal structure, in which honeycomb-like hexagons are formed by linking one carbon to three neighboring carbon atoms. Carbon nanotubes are divided into single-walled carbon nanotubes (SWCNT), double-walled carbon nanotubes and (DWCNT), multi-walled carbon nanotubes (MWCNT) according to the number of tubes.

Carbon nanotubes have excellent electrical and mechanical properties, thermal stability, and adsorption and transport properties, so a great deal of research is being conducted for applications in a variety of fields. While multi-walled carbon nanotubes with relatively competitive prices can be domestically produced in Korea, single-walled and double-walled carbon nanotubes having particularly excellent electrical conductivity are yet to be domestically produced and are still mainly imported.

Unlike multi-walled carbon nanotubes having diameters of 4 nm or larger, carbon nanotubes having diameters of 3 nm or smaller have low dispersion stability because highly dense bundles of several millimeters are formed with flake appearance after synthesis due to strong van der Waals attraction resulting from small diameters and high aspect ratios. Thus, the de-bundling of the bundles to realize carbon nanotube dispersion in a dispersion medium by making such strong van der Waals attraction weak is important.

Existing de-bundling has used physical grinding methods based on probe-type ultrasonic dispersion or using devices such as a high-pressure homogenizer, or chemical oxidation methods using an oxidizing agent while applying a strong shear stress. However, although the methods described above can improve the dispersion stability of carbon nanotubes in the dispersion solution by breaking the length of the carbon nanotubes to 0.1 to 3 μm, the inherent sp² hexagonal carbon ring structure of the carbon nanotubes is destroyed during this process. Therefore, with the decreasing electrical conductivity below 100 S/cm, a separate post-reduction process is required to restore the sp² structure. Additionally, there is a problem in that the electrical conductivity fails to exceed 1,000 S/cm even after the reduction process, SO the carbon nanotubes are chemically unstable.

In other words, attempts have been made to obtain the dispersibility of carbon nanotubes through various mechanical pulverization processes in which a high shear stress is applied to carbon nanotubes with the use of dispersants. However, in this case, non-conductive dispersants are dispersed in a form surrounding the surface of the carbon nanotubes, causing high interfacial resistance between the carbon nanotubes while leading to structural defects therein. Accordingly, the inherent high electrical conductivity and concentration of the carbon nanotubes are reduced, leading to deterioration in processability, which is disadvantageous.

In “COMPOSITION FOR CARBON NANOTUBE NANOCOMPOSITE CONDUCTIVE FIBER AND PREPARATION METHOD THEREOF (KR 10-2019-0108734 A)”, proposed is a technology allowing carbon nanotubes to be dispersed in a polymer by de-bundling through acid treatment in which acid and an alkali metal salt are mixed to keep the carbon nanotubes from being oxidized or keep carbon sp² bonds on the surface from being broken.

This technique aims to provide electrical conductivity by dispersing carbon nanotubes as conductive fillers in an organic solvent-based non-electrically conductive polymer matrix. However, there is a problem in that the carbon nanotubes are only enabled to be dispersed in the polymer matrix when combining mechanical dispersion methods using a high-pressure homogenizer and the like because the length of the carbon nanotubes is excessively long at 100 μm or higher immediately after pretreatment. Additionally, this technology has limitations of being only applicable to nanocomposite materials such as polymer solutions containing 1,000 to 10,000 parts by weight of a polymer per 100 parts by weight of carbon nanotubes.

Recently, there has been a rapidly growing demand for single-walled or double-walled carbon nanotubes as conductive additives for the next-generation lithium secondary batteries, which have higher electrical conductivity than carbon black or multi-walled carbon nanotubes and can be advantageous in improving durability during charge/discharge cycles. In this regard, in “NEGATIVE ELECTRODE, SECONDARY BATTERY INCLUDING NEGATIVE ELECTRODE, AND MANUFACTURING METHOD OF NEGATIVE ELECTRODE (KR 10-2021-0015714 A)”, disclosed is a carbon nanotube structure in which 2 to 5,000 single-walled carbon nanotube units are connected side by side, the carbon nanotube structure formed by applying shear force to a mixed solution including a dispersion medium, a dispersant, and bundled single-walled carbon nanotubes to disperse the single-walled carbon nanotubes, wherein a negative electrode active material layer includes 0.01 to 1.0 wt % of the carbon nanotube structure.

These single-walled carbon nanotubes undergo a process of pre-dispersing carbon nanotubes in a dispersant solution containing a dispersant dissolved in a dispersion medium to be applied to a negative electrode slurry. In other words, the carbon nanotubes are dispersed by a principle in which after mixing the carbon nanotubes in the dispersant solution, a strong shear force is applied to cut the carbon nanotubes while allowing the dispersant to infiltrate between the carbon nanotube bundles. In this case, the infiltration capacity enabling the dispersant to infiltrate between the carbon nanotube bundles is greatly affected by the dispersant content in the dispersant solution.

This is because, with the increasing dispersant content, the viscosity of the solution increases, showing that the infiltration capacity of the dispersant between the carbon nanotube bundles tends to decrease. Such a dispersion method using dispersants has a trade-off in that the higher the dispersant content with respect to the carbon nanotubes, the better the dispersibility of the carbon nanotubes, but the lower the electrical conductivity. Therefore, the content range of the dispersant relative to the carbon nanotubes is characterized by being limited by the type of dispersant.

Using a separate electrode binder, in addition to dispersants for carbon nanotube dispersion, is a typical method to obtain binding strength between active material particles in electrodes and between an active material layer and a current collector in secondary batteries. In this case, carbon nanotubes serving as conductive additives are pre-dispersed in a dispersant solution and then undergo an additional dispersion procedure in a binder solution in which the electrode binder is dissolved. Accordingly, a pre-dispersion solution with high carbon nanotube content is required to prevent a negative electrode slurry for secondary batteries from becoming excessively watery and resulting in poor coating properties. However, when increasing the content of carbon nanotubes to prepare a pre-dispersion solution with high carbon nanotube content, the dispersant content must also be increased to maintain dispersibility, as described above. Additionally, the high viscosity resulting therefrom reduces the infiltration capacity of the dispersants, leading to deterioration in dispersibility, which is problematic. As a result, there is a disadvantage in that the content of single-walled carbon nanotubes in the single-walled carbon nanotube pre-dispersion solution containing the dispersants is low.

As another method of dispersing carbon nanotubes, there is a chemical method to obtain dispersibility by introducing oxygen-containing functional groups into carbon nanotubes using an oxidizing agent or strong acid. However, this method is also disadvantageous in that the inherent electrical properties of carbon nanotubes deteriorate, and a post-reduction process must be performed to restore the electrical properties.

Therefore, there is a need to develop technology for carbon nanotubes that not only facilitates redispersion without involving mechanical dispersion and minimizes defects by not destroying intrinsic properties, but also enables excellent electrical, mechanical, and thermal properties to be obtained.

Additionally, there is a demand for technology that enables carbon nanotubes that are highly crystalline with minimum defect formation, can be applied to an electrode slurry for secondary batteries without using dispersants, and satisfy dispersibility to be used as a conductive additive. Hence, the inventors of the present disclosure focused on the above technical demands and developed a conductive composite material in which carbon nanotubes are directly dispersed in a polymer binder without using a dispersant, a negative electrode slurry using the same, a negative electrode, and a lithium secondary battery, thereby completing the present disclosure.

### DISCLOSURE

### Technical Problem

The present disclosure, which has been made to solve the problems mentioned above, aims to provide a sludge containing highly crystalline carbon nanotubes in which defects are structurally prevented from being formed and a preparation method thereof, a conductive composite material based on high-concentration low-defect carbon nanotubes, the conductive composite material having high crystallinity with minimum defects while not requiring a separate dispersant, a negative electrode slurry using the same, a negative electrode, and a lithium secondary battery.

### Technical Solution

In order to solve one of the technical problems described above, the present disclosure provides a low-defect carbon nanotube sludge characterized by containing carbon nanotubes having crystallinity while satisfying Relational Expression 1 below.

$$5 \leq {I}_{G} / {I}_{D} \leq 50 \qquad [ Relational Expression 1 ]$$

However, I_{G}/I_{D} is a value calculated as a ratio of a maximum peak intensity (I_{G}) measured at a wavenumber region of 1,580±50 cm⁻¹ to a maximum peak intensity (I_{D}) measured at a wavenumber region of 1,360±50 cm⁻¹ in a Raman spectrum.

The present disclosure is characterized in that the carbon nanotubes include one or more types selected from the group consisting of single-walled carbon nanotubes and double-walled carbon nanotubes.

The present disclosure is characterized in that the carbon nanotubes are obtained by introducing carbon nanotubes into a solution in which an alkali metal salt is dissolved in a first acid, leaving the resulting solution, further introducing a second acid thereinto, applying shear stress to de-bundle the introduced carbon nanotubes, and neutralizing and washing the de-bundled carbon nanotubes.

The present disclosure is characterized in that the first acid includes one or more selected from the group consisting of sulfuric acid, fuming nitric acid, red fuming nitric acid, and phosphoric acid, and the second acid includes one or more selected from the group consisting of nitric acid, hydrogen peroxide, and hydrochloric acid.

The present disclosure is characterized in that the alkali metal salt includes one or more selected from the group consisting of a nitric acid compound, a sulfuric acid compound, and a phosphoric acid compound that contain one or more elements among lithium (Li), sodium (Na), potassium (K), rubidium (Rb), and cesium (Cs).

The present disclosure is characterized in that the carbon nanotubes have a length in a range of 3 to 70 μm.

In order to solve another technical problem described above, the present disclosure provides a method of preparing a low-defect carbon nanotube sludge, which is characterized by including: preparing a mixture by introducing carbon nanotubes into a solution in which an alkali metal salt is dissolved in a first acid and leaving the resulting solution; de-bundling the carbon nanotubes by introducing a second acid into the prepared mixture and applying shear stress; and obtaining a carbon nanotubes by neutralizing and washing the resulting mixture containing the de-bundled carbon nanotubes, in which the carbon nanotubes have crystallinity while satisfying Relational Expression 1 below.

$$5 \leq {I}_{G} / {I}_{D} \leq 50 \qquad [ Relational Expression 1 ]$$

However, I_{G}/I_{D} is a value calculated as a ratio of a maximum peak intensity (I_{G}) measured at a wavenumber region of 1,580±50 cm⁻¹ to a maximum peak intensity (I_{D}) measured at a wavenumber region of 1,360±50 cm⁻¹ in a Raman spectrum.

The present disclosure is characterized in that the carbon nanotubes include one or more types selected from the group consisting of single-walled carbon nanotubes and double-walled carbon nanotubes.

The present disclosure is characterized in that the first acid includes one or more selected from the group consisting of sulfuric acid, fuming nitric acid, red fuming nitric acid, and phosphoric acid, and the second acid includes one or more selected from the group consisting of nitric acid, hydrogen peroxide, and hydrochloric acid.

The present disclosure is characterized in that the alkali metal salt includes one or more selected from the group consisting of a nitric acid compound, a sulfuric acid compound, and a phosphoric acid compound that contain one or more elements among lithium (Li), sodium (Na), potassium (K), rubidium (Rb), and cesium (Cs).

In order to solve another technical problem described above, the present disclosure provides a conductive composite material based on low-defect carbon nanotubes, the composite material characterized by including a polymer binder and sludge-form carbon nanotubes dispersed in the polymer binder. In this case, the carbon nanotubes are the carbon nanotubes described above.

In order to solve another technical problem described above, the present disclosure provides a negative electrode slurry including silicon-based active materials and the conductive composite material described above.

In order to solve another technical problem described above, the present disclosure provides a negative electrode including a negative electrode active material layer formed by the negative electrode slurry described above.

In order to solve the other technical problem described above, the present disclosure provides a lithium secondary battery including the negative electrode described above.

### Advantageous Effects

According to the present disclosure for solving the technical problems described above, a carbon nanotube sludge contains crystalline carbon nanotubes obtained by introducing carbon nanotubes into a solution in which an alkali metal salt is dissolved in a first acid, leaving the resulting solution, further introducing a second acid thereinto, applying shear stress to de-bundle the introduced carbon nanotubes, and neutralizing and washing the de-bundled carbon nanotubes. As a result, electrical, mechanical, and thermal properties can be improved with few defects.

Additionally, according to a conductive composite material based on low-defect carbon nanotubes and composed of carbon nanotube-polymer binder in the present disclosure, despite being de-bundled using a chemical dispersion method with a strong acid, defect formation can be minimized, thereby having high crystallinity, and a post-reduction process is unnecessary. Accordingly, the carbon nanotubes can be directly dispersed in the polymer binder without using a dispersant.

Additionally, when mixing the conductive composite material with silicon-based active materials to form a negative electrode slurry and constituting the negative electrode slurry using a negative electrode active material layer by forming the length of the carbon nanotubes, which are a linear conductive additive, to be in a range of 3 to 70 μm, the carbon nanotubes can maintain a stable electrical network by connecting the silicon-based active materials. Accordingly, redispersion can be facilitated even without involving mechanical dispersion that destroys the inherent properties of the carbon nanotubes. Furthermore, an electrochemical interface with the silicon-based active materials can be easily formed even with a small amount of the carbon nanotubes by being optimized for the size of the silicon-based active materials.

Additionally, the amount of the carbon nanotubes used can be reduced compared to the amount of existing carbon black-based conductive additives used. As a result, a larger amount of the silicon-based active materials can be introduced for the same volume, which not only can increase energy density and obtain the structural stability of the silicon-based active materials, but also can prevent deterioration from occurring. Thus, long-life characteristics of lithium secondary batteries can be obtained.

Additionally, large-scale synthesis of the carbon nanotube sludge can be possible through the present disclosure, thus actively enabling the application thereof not only as conductive additives for secondary batteries but also to various fields such as heat dissipation, shielding, and heat generation that require electrical, thermal, and physical lightweight properties.

Furthermore, the application area can extend to the fields of advanced materials and polymer composite materials that require high performance with small amounts among application markets where existing multi-walled carbon nanotubes are mainly used.

### DESCRIPTION OF DRAWINGS

FIG. 1 is an SEM image showing the surface of buckypaper prepared using single-walled carbon nanotubes according to Preparation Example 1;

FIG. 2 is an optical microscope image showing a dispersion solution prepared using single-walled carbon nanotubes according to Preparation Example 1;

FIG. 3 is a graph showing the Raman spectrum of single-walled carbon nanotubes according to Preparation Example 1;

FIG. 4 is an SEM image showing the surface of buckypaper prepared using single-walled carbon nanotubes according to Preparation Example 2;

FIG. 5 is an optical microscope image showing a dispersion solution prepared using single-walled carbon nanotubes according to Preparation Example 2;

FIG. 6 is an SEM image examined after coating a copper current collector with a negative electrode slurry according to Example 1;

FIG. 7 is an SEM image examined after coating a copper current collector with a negative electrode slurry according to Comparative Example 1;

FIG. 8 is an SEM image examined after coating a copper current collector with a negative electrode slurry according to Comparative Example 2; and

FIG. 9 is a graph showing the capacity retention rate according to charge/discharge cycles of Example 1 and Comparative Examples 1 and 2.

### BEST MODE

The present disclosure can be variously modified in many different forms, so preferred embodiments thereof will be described in detail herein. However, the present disclosure should not be construed as being limited to these embodiments, but should be construed as covering modifications, equivalents, or alternatives falling within the ideas and technical scopes of the present disclosure.

It will be further understood that the terms “comprises”, “includes”, or “has” when used herein specify the presence of stated features, regions, integers, steps, operations, elements, and/or components, but do not preclude the presence or addition of one or more other features, regions, integers, steps, operations, elements, components, and/or combinations thereof.

Unless otherwise defined, all terms used herein, including technical or scientific terms, have the same meaning as commonly understood by those skilled in the art to which the present disclosure pertains. It will be further understood that terms, such as those defined in commonly used dictionaries, should be interpreted as having a meaning that is consistent with their meaning in the context of the related art and the present disclosure, and will not be interpreted in an idealized or overly formal sense unless expressly so defined herein.

Terms used herein are used only to describe specific embodiments and are not intended to limit the present disclosure. The singular expressions include the plural expressions unless the context clearly indicates otherwise.

The present disclosure relates to a low-defect carbon nanotube sludge and a conductive carbon nanotube-polymer binder composite material based on the low-defect carbon nanotubes.

Defects are a factor leading to deterioration in mechanical, thermal, and electrical properties of carbon nanotubes, control of defects in carbon nanotubes is important. For this reason, the present disclosure provides a conductive composite material in which low-defect carbon nanotubes are deposited in a polymer binder after obtaining the low-defect carbon nanotubes obtained in a sludge form by introducing carbon nanotubes into a solution in which an alkali metal salt is dissolved in a first acid, leaving the resulting solution, further introducing a second acid into the resulting mixture to de-bundle the introduced carbon nanotubes, and neutralizing and washing the de-bundled carbon nanotubes.

While the carbon nanotubes are mixed in the polymer binder solution in the sludge form, the carbon nanotubes and the polymer binder are mixed in a weight ratio in a range of 1:2 to 9, such that the dispersibility of the carbon nanotubes may be appropriately adjusted. The closer the weight ratio of the polymer binder is to 9, the more easily the carbon nanotubes are dispersed. However, there is a disadvantage in that a larger amount of carbon nanotubes is required to be used for higher electrical conductivity because the electrical conductivity is reduced. When the weight ratio of the polymer binder is less than 2, dispersion of the carbon nanotubes may be challenging. Thus, the weight ratio of the carbon nanotubes to the polymer binder is preferably in the range of 1:2 to 9.

When mixing the carbon nanotubes with the polymer binder as described above, the conductive composite material in which the carbon nanotubes have dispersibility on the polymer binder is formed even without using a dispersant. Therefore, when preparing a negative electrode slurry, the carbon nanotubes in the negative electrode slurry may obtain appropriate dispersibility simply by introducing a negative electrode active material into the conductive composite material based on the carbon nanotubes.

The polymer binder constituting the conductive composite material provides bonding strength to the carbon nanotube sludge, enabling a stable negative electrode to be formed while surrounding silicon-based active materials that will constitute the negative electrode slurry. As the polymer binder, an aqueous or organic polymer binder that does not affect reactions in an electrode of a lithium secondary battery may be used.

As the aqueous polymer binders, one or more selected from the group consisting of carboxymethyl cellulose (CMC), styrene-butadiene rubber (SBR), polyacrylic acid (PAA), polyvinyl alcohol (PVA), polyvinyl pyrrolidone, polyacrylamide, polyacrylonitrile (PAN), polyvinyl methyl ether (PVME), polypropylene glycol (PPG), poly(N-isopropylacrylamide) (PNIPAM), and polyethylene oxide (PEO) may be used.

In the case of the organic polymer binder, one or more selected from the group consisting of polyvinylidene fluoride (PVDF), polystyrene, poly(methyl methacrylate), polyethylene, polypropylene, polyvinyl chloride, polyimide, polyamide, polyamide-imide, polyvinylidene fluoride-co-hexafluoropropylene, polyvinylidene fluoride-co-trichloroethylene, polybutylacrylate, polyvinyl acetate, an ethylene vinyl acetate copolymer (polyethylene-co-vinyl acetate), and polyarylate may be used.

The carbon nanotubes constituting the conductive composite material, which are a linear conductive additive, may be composed of the low-defect carbon nanotube sludge. Typically, one or more types of particulate conductive additive selected from the group consisting of super P black (SPB), carbon black (CB), and Ketjen black (KB) have been used for general purposes. However, the particulate conductive additive is only attached to the surface of the particulate silicon-based active materials even when mixed with the silicon-based active materials constituting a negative electrode active material layer, but fails to connect the silicon-based active materials. Thus, there is a disadvantage in that the electrical network performance deteriorates.

Hence, in the present disclosure, the conductive composite material may be composed of the linear conductive additive to connect the silicon-based active materials, thereby improving the electrical properties. To this end, the carbon nanotubes are characterized by having crystallinity while satisfying Relational Expression 1 below.

$$5 \leq {I}_{G} / {I}_{D} \leq 50 \qquad [ Relational Expression 1 ]$$

In Relational Expression 1, I_{G}/I_{D} is a value calculated as a ratio of a maximum peak intensity (I_{G}) measured at a wavenumber region of 1,580±50 cm⁻¹ to a maximum peak intensity (I_{D}) measured at a wavenumber region of 1,360±50 cm⁻¹ in a Raman spectrum.

In this regard, the Raman spectrum of the carbon nanotubes may be obtained by performing Raman spectroscopy on the carbon nanotubes. This Raman spectroscopy may be performed on a predetermined area selected from the surface of the carbon nanotubes using a Raman spectrometer and Raman mapping.

Raman spectroscopy refers to a spectroscopic method that determines the frequency of a molecule from the Raman effect, a phenomenon in which scattered light equivalent to the frequency difference of the molecule is generated when exposed to monochromatic excitation light such as laser light. Through such Raman spectroscopy, the crystallinity of the carbon nanotubes may be quantified and measured.

In expressing the G band intensity compared to the D band intensity in Raman spectroscopy as the crystallinity of the carbon nanotubes, the peak present at a wavenumber region of 1,580±50 cm⁻¹ is called the G band. This peak represents the sp² bonds in the carbon nanotubes, indicating that the carbon crystals are free of structural defects. Furthermore, the peak present at a wavenumber region of 1, 360±50 cm⁻¹ is called the D band. This peak represents the sp³ bonds in the carbon nanotubes, indicating that carbon has structural defects.

The maximum peak intensity values of the G and D bands are called I_{G} and I_{D}, respectively, and the crystallinity of the carbon nanotubes may be quantified through a Raman spectral intensity ratio (I_{G}/I_{D}), the ratio between I_{G} and I_{D}, and measured. In other words, I_{G}/I_{D} is a measure of relative crystallinity, indicating the density of defects.

The higher the Raman spectral intensity ratio, the fewer the structural defects in the carbon nanotubes. Therefore, the carbon nanotubes having a Raman spectral intensity ratio in a range of 5 to 50 may enable crystallinity to be obtained while realizing even better conductivity.

When the Raman spectral intensity ratio is lower than 5, a large amount of amorphous carbon may be contained, making the crystallinity of the carbon nanotubes poor. As a result, the effect of improving conductivity may be insignificant when applied to a negative electrode of a lithium secondary battery. Thus, the Raman spectral intensity ratio of the carbon nanotubes is preferably 5 or higher. When the Raman spectral intensity ratio exceeds 50, the carbon nanotubes may be likely to be cut or destroyed by external stimuli, which is undesirable. More preferably, I_{G}/I_{D} is in the range of 15 to 35.

In the present disclosure, the carbon nanotubes may include one or more types selected from the group consisting of single-walled carbon nanotubes and double-walled carbon nanotubes. In particular, some double-walled carbon nanotubes may be stochastically contained in the process of synthesizing currently available single-walled carbon nanotubes. While the crystallinity of such carbon nanotubes varies depending on synthesis mechanisms, high crystallinity is known to be obtained when the Raman spectral intensity ratio (I_{G}/I_{D}), representing the crystallinity, reaches 4.5 to 60 immediately after the synthesis of such carbon nanotubes. On the contrary, in the case of multi-walled carbon nanotubes having diameters of 4 nm or larger, the crystallinity is known to be low because a Raman spectral intensity ratio (I_{G}/I_{D}) is typically lower than 0.5. On that basis, it is confirmed that the carbon nanotubes, according to the present disclosure, have high crystallinity by allowing the Raman spectral intensity ratio (I_{G}/I_{D}) to satisfy the range of 5 to 50.

The carbon nanotubes may have a length in a range of 3 to 70 μm. The carbon nanotubes may be adjusted to a length optimized for the size of the silicon-based active materials to form an electrochemical interface with the silicon-based active materials in a lithium secondary battery. In this case, the length may be adjusted to fall within the range of 3 to 70 μm such that the electrical network is well-maintainable by connecting the silicon-based active materials. Preferably, the length is in the range of 5 to 30 μm. When the carbon nanotubes have a length smaller than 3 μm, the length is extremely short to connect the silicon-based active materials, making the electrical network formation unstable, and the length thereof exceeding 70 μm is disadvantageous to the interfacial bonding with the silicon-based active materials.

The carbon nanotubes may have an electrical conductivity of 600 to 5,000 S/cm while having a length in a range of 3 to 70 μm, without involving additional thermal or chemical reduction processes. The carbon nanotubes of the present disclosure may have an electrical conductivity in a range of 600 to 5,000 S/cm, which is more preferably in the range of 1,000 to 3,000 S/cm, while maintaining the inherent sp²-hexagonal carbon rings.

The low-defect carbon nanotube sludge having crystallinity may be prepared through the following steps: S10 of preparing a mixture by introducing carbon nanotubes into a solution in which an alkali metal salt is dissolved in a first acid and leaving the resulting solution; S20 of de-bundling the carbon nanotubes by introducing a second acid into the prepared mixture and applying shear stress; and S30 of obtaining carbon nanotubes by neutralizing and washing the resulting mixture containing the de-bundled carbon nanotubes.

According to the preparation method described above, the mixture is first prepared by introducing the carbon nanotubes into the solution in which the alkali metal salt is dissolved in the first acid and leaving the resulting solution (S10).

In other words, in this process, the carbon nanotubes are introduced into the solution in which the alkali metal salt is dissolved in the first acid. In this case, the first acid used may include one or more selected from the group consisting one or more selected from the group consisting of sulfuric acid, fuming nitric acid, red fuming nitric acid, and phosphoric acid. Additionally, the alkali metal salt may include one or more selected from the group consisting of a nitric acid compound, a sulfuric acid compound, and a phosphoric acid compound that contain one or more elements among lithium (Li), sodium (Na), potassium (K), rubidium (Rb), and cesium (Cs).

Next, the carbon nanotubes are de-bundled by introducing the second acid into the prepared mixture and applying the shear stress (S20).

When the second acid is introduced into the mixture, the volume of the mixture expands. To avoid crystallographic damage to the carbon nanotubes, the mixture is preferably mixed with a low shear stress while introducing the second acid in an ice bath at a temperature of 10° C. or lower and being stirred with an impeller using a blade made of Teflon on an overhead stirrer such that the temperature of the mixture does not exceed 30° C. However, the second acid used for the volume expansion of the mixture may include one or e selected from the group consisting of nitric acid, hydrogen peroxide, and hydrochloric acid.

The carbon nanotubes may be de-bundled by applying the low shear stress after the volume expansion of the mixture. In this case, any stirring mechanism capable of preventing crystallographic damage to the carbon nanotubes may be applied without limitation. Additionally, a heating reaction is preferably performed in a reaction bath for strong acid at a temperature in a range of 60° C. to 120° C. at a speed in a range of 50 to 150 rpm or less while being stirred using a Teflon impeller on an overhead stirrer for high viscosity such that oxygen-containing functional groups are formed only at the terminals of the carbon nanotubes and the carbon nanotubes are de-bundled by the low shear stress. De-bundling means that a bundle of these carbon nanotubes is separated strand by strand, making the de-bundled carbon nanotubes easier to disperse in the polymer binder.

In this case, the total content of the first and second acids per 1 g of the carbon nanotubes is in a range of 10 to 80 ml, leading to a decrease in the amount of strong acid used per 1 g of the carbon nanotubes and a decrease in the amount of acidic wastewater used for acid washing. When the total content of the first and second acids used is lower than 10 ml, there is a limitation in completing the de-bundling, and when the total content of the first and second acids exceeds 80 ml, the amount of acidic wastewater to be removed increases, and the crystallinity of the de-bundled carbon nanotubes may be adversely affected, which is undesirable.

Lastly, the carbon nanotubes are obtained by neutralizing and washing the resulting mixture containing the de-bundled carbon nanotubes (S30).

After the earlier de-bundling process, the mixture was left at room temperature for stabilization. Then, the sludge containing only water and the carbon nanotubes may be obtained from a precipitate subjected to neutralization and washing processes to remove the used acids and alkali metal salt. The aqueous carbon nanotube sludge in the precipitate form, obtained after acid washing, may have a concentration in a range of 1 to 5 wt %. When the concentration of the non-volatile phase in the sludge is less than 1 wt %, there is a problem in that depending on the acid washing process, the yield of the carbon nanotubes decreases, or the filtering takes a longer time, and when the concentration of the non-volatile phase in the sludge exceeds 5 wt %, the carbon nanotubes may be reaggregated, which is undesirable.

According to the conductive carbon nanotube-polymer binder material in which the low-defect carbon nanotube sludge, obtained through the process described above, is dispersed in the polymer binder, the carbon nanotubes having a length suitable for electrical connection between the silicon-based active materials may be dispersed in the polymer binder without using a dispersant. Additionally, an additional concentration process is not required to increase the concentration of the negative electrode slurry. Accordingly, this may improve the process that has been inconvenient due to an additional solvent evaporation process required to avoid deterioration in coating properties that enables the coating of a current collector with an active material layer in a desired thickness to be uniform, because when existing single-walled carbon nanotubes are mechanically ground to be short, dispersed using a dispersant, and then mixed with a binder solution to prepare a negative electrode slurry, the negative electrode slurry becomes excessively watery.

In the low-defect carbon nanotube sludge of the present disclosure, the conductive composite material based on the low-defect carbon nanotubes is mixed with the silicon-based active materials to constitute the negative electrode slurry, and the negative electrode slurry is applied on the surface of a current collector, such that the negative electrode active material layer may be formed. The silicon-based active materials may be pure metal silicon, a silicon alloy, or silicon oxide (SiOₓ), where x may be a value satisfying 0<x≤2.

The negative electrode forms an electrode assembly with a separator and a positive electrode including a positive electrode active material layer, and the electrode assembly and an electrolyte are stored in an exterior case, thereby constituting a lithium secondary battery. In the case of the current collector, copper foil, nickel foil, stainless steel foil, titanium foil, nickel foam, copper foam, a polymer substrate coated with a conductive metal, or a combination thereof may be used.

Hereinafter, examples of the present disclosure will be described in more detail as follows. However, the following examples are merely illustrative to aid understanding of the present disclosure and are not intended to limit the scope of the present disclosure.

### <Preparation Example 1> Preparation of Single-Walled Carbon Nanotubes (Method of Present Disclosure)

First, 200 ml of sulfuric acid (H₂SO₄) in which 50 g of potassium nitrate (KNO₃) was dissolved was introduced into 10 g of single-walled carbon nanotubes and then left for 15 hours such that the single-walled carbon nanotubes were well-soaked. Then, 100 ml of 60% purity nitric acid (HNO₃) was slowly mixed therein in an ice bath environment while being stirred with an impeller using a blade made of Teflon on an overhead stirrer such that the temperature of the resulting mixture did not exceed 30° C. In this case, the total amount of sulfuric acid and nitric acid used for 10 g of the single-walled carbon nanotubes was 300 ml. During this process, the mixture of high-concentration single-walled carbon nanotubes expanded in volume while the rotational torque for stirring with the impeller increased significantly. When the introduction of nitric acid was completed, the resulting mixture was stirred at a speed of 80 rpm for 15 hours in an oil bath at a temperature of 90° C.

After being stirred, the mixture of the single-walled carbon nanotubes was cooled to room temperature and then slowly introduced into 1.5 L of distilled water for neutralization. Next, a precipitate was collected after centrifugation at a speed of 8,000 rpm for 30 minutes, and distilled water was additionally introduced until the pH of the supernatant reached 2.5 or higher for acid washing, thereby obtaining single-walled carbon nanotubes.

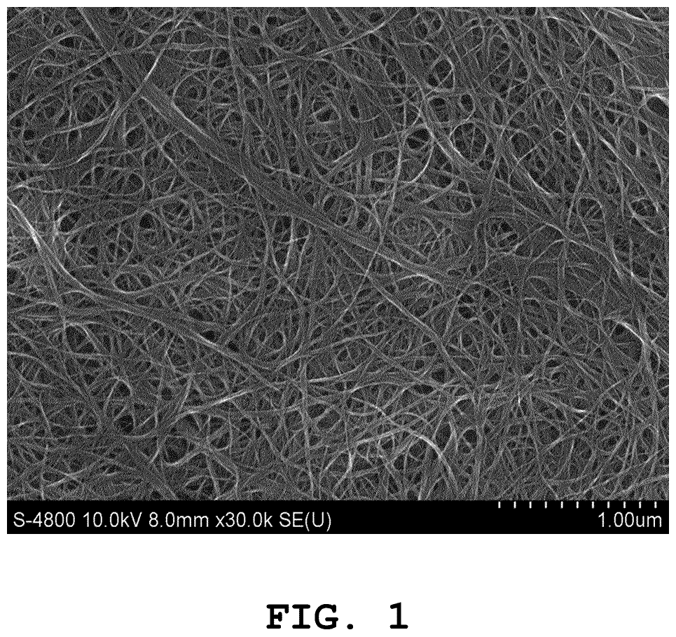

FIG. 1 is an SEM image showing the surface of buckypaper prepared using the single-walled carbon nanotubes according to Preparation Example 1. Referring to FIG. 1, the SEM image showing the surface of the film-type buckypaper prepared using the chemically de-bundled single-walled carbon nanotubes according to Preparation Example 1, the buckypaper had an electrical conductivity of 2,500 S/cm.

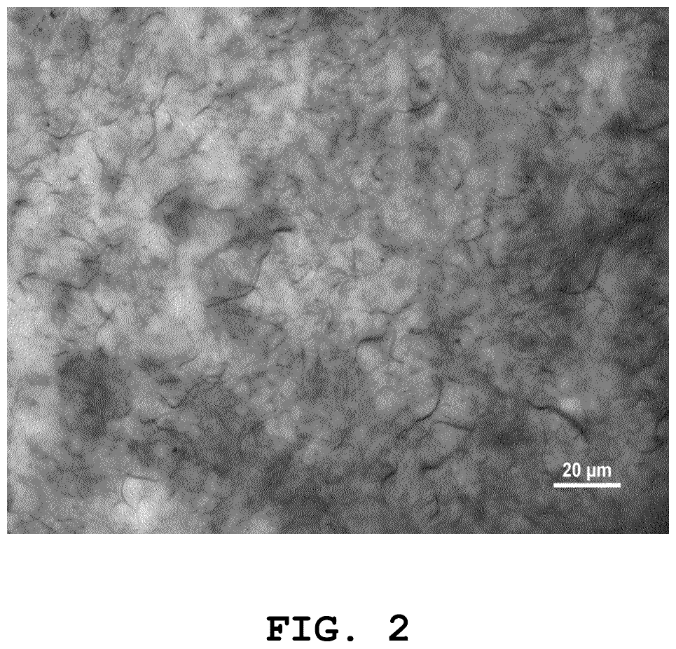

FIG. 2 is an optical microscope image showing a dispersion solution prepared using the single-walled carbon nanotubes according to Preparation Example 1, which shows an aqueous single-walled carbon nanotube dispersion solution prepared by performing bath-type ultrasonication with low ultrasonic intensity using sodium cholate, one type of dispersant, in the single-walled carbon nanotubes to confirm the length of the single-walled carbon nanotubes prepared in Preparation Example 1. Referring to FIG. 2, it is seen that the single-walled carbon nanotubes are evenly distributed within 30 μm in length.

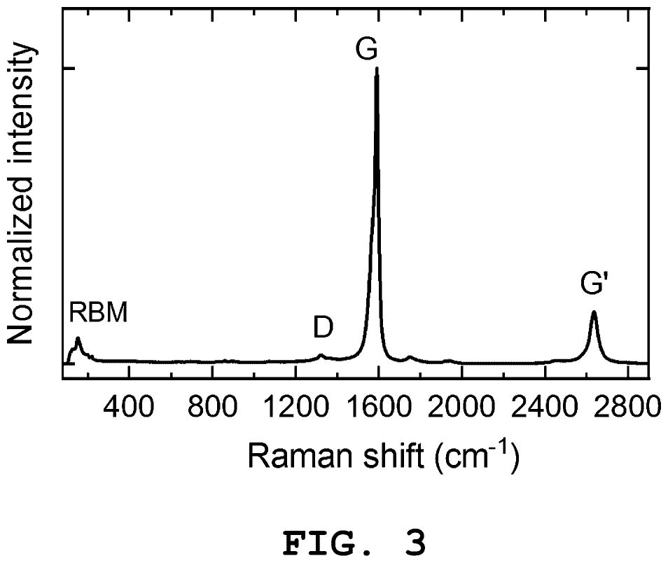

FIG. 3 is a graph showing the Raman spectrum of the single-walled carbon nanotubes according to Preparation Example 1. In other words, FIG. 3 shows the Raman spectrum of the chemically de-bundled single-walled carbon nanotubes according to Preparation Example 1, confirming that an I_{G}/I_{D} ratio, which is a peak intensity ratio of the G band indicating the crystallinity of the carbon sp² structure to the D band resulting from defects formed in the sp² structure, is 33.3. Additionally, radial breathing mode (RBM), a characteristic peak of highly crystalline single-walled carbon nanotubes observed at a low frequency below 300 cm⁻¹, indicates that the diameter of the carbon nanotubes is at a level of 1.9 nm. This shows that the single-walled carbon nanotubes are not damaged even after being chemically de-bundled and maintain excellent crystallinity.

### <Preparation Example 2> Preparation of Single-Walled Carbon Nanotubes (Existing Method)

First, 400 ml of 60% purity nitric acid (HNO₃) was introduced into 10 g of single-walled carbon nanotubes and then sonicated for 20 minutes while being stirred with an impeller at a speed of 70 rpm using a blade made of Teflon on an overhead stirrer. Then, 600 ml of sulfuric acid (H₂SO₄) in which 100 g of potassium nitrate (KNO₃) was dissolved was mixed therein in an ice water bath environment. In this case, the total amount of sulfuric acid and nitric acid used for 10 g of the single-walled carbon nanotubes was 1,000 ml. When the introduction of sulfuric acid was completed, the resulting mixture was stirred at a speed of 80 rpm for 15 hours in an oil bath at a temperature of 60° C.

After being stirred, the mixed acidic solution of the single-walled carbon nanotubes was cooled to room temperature and then slowly introduced into 8 L of distilled water for neutralization. Next, a precipitate was collected after centrifugation at a speed of 8,000 rpm for 30 minutes, and distilled water was additionally introduced until the pH of the supernatant reached 2.5 or higher for acid washing, thereby obtaining single-walled carbon nanotubes.

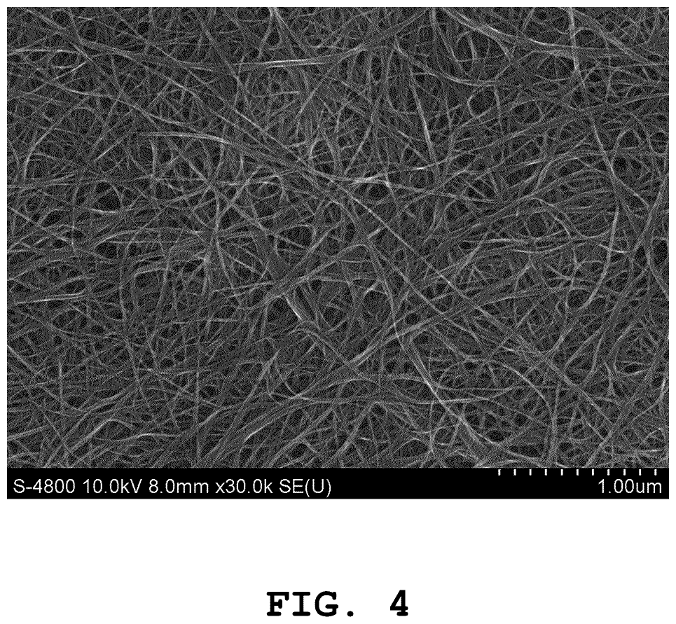

FIG. 4 is an SEM image showing the surface of buckypaper prepared using the single-walled carbon nanotubes according to Preparation Example 2. When examining the SEM image showing the surface of the buckypaper prepared using the single-walled carbon nanotubes obtained through Preparation Example 2, referring to an existing method of processing single-walled carbon nanotubes, it is confirmed that the conformation of the single-walled carbon nanotubes is not much different from that of FIG. 1 showing the result of Preparation Example 1.

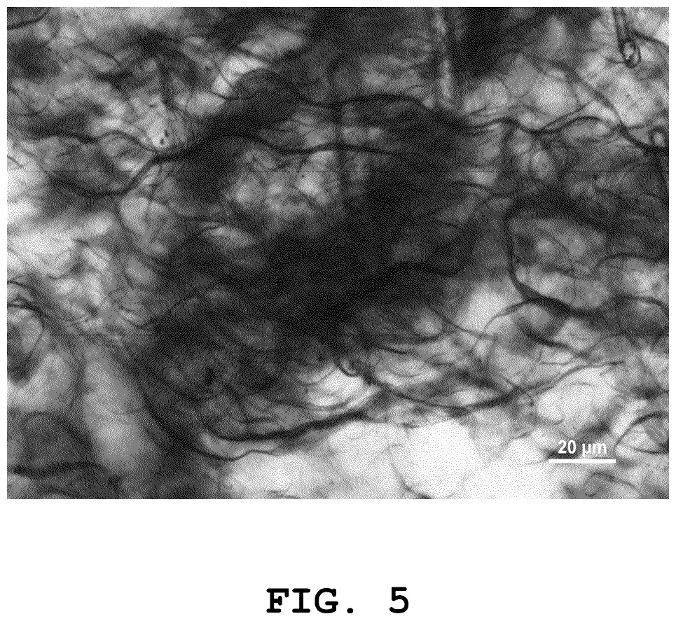

However, FIG. 5 shows an optical microscope image of an aqueous single-walled carbon nanotube dispersion solution prepared using the single-walled carbon nanotubes according to Preparation Example 2 by the method same as that in Preparation Example 1. From FIG. 5, the length and dispersion type of the single-walled carbon nanotubes may be confirmed. In other words, even though there is no significant difference in the surface SEM images of the film-type single-walled carbon nanotube buckypaper that is solvent-free through Preparation Examples 1 and 2, it is confirmed that the length and dispersion state vary significantly in a dispersed phase where the solvent coexists.

On that basis, it is seen that without involving destructive physical dispersion for obtaining dispersibility by cutting the length of the single-walled carbon nanotubes, non-destructive redispersion to a desired concentration is facilitated, and the crystallinity of the chemically de-bundled single-walled carbon nanotubes is well-maintained, such that the I_{G}/I_{D} ratio is in the range of 5 to 50.

### Example 1

A conductive composite material was prepared by mixing the single-walled carbon nanotubes prepared in Preparation Example 1 and a polymer binder (PAA) in a weight ratio of 1:9. Then, the conductive composite material and silicon-based active materials (silicon oxide) were mixed to prepare a negative electrode slurry. In this case, the silicon-based active materials, the single-walled carbon nanotubes prepared in Preparation Example 1, and the PAA to serve as the polymer binder were mixed in a weight ratio of 80:2:18.

### Comparative Example 1

In Comparative Example 1, a negative electrode slurry was prepared by mixing silicon-based active materials (silicon oxide), carbon black, and PAA to serve as a polymer binder in a weight ratio of 80:10:10, unlike Example 1 in which the single-walled carbon nanotubes were used as a conductive additive.

### Comparative Example 2

In Comparative Example 2, a negative electrode slurry was prepared by mixing single-walled carbon nanotubes of Preparation Example 1 with the silicon-based active materials (silicon oxide), carbon black, and PAA to serve as the polymer binder of Comparative Example 1. In this case, the silicon-based active materials, carbon black, the single-walled carbon nanotubes, and the PAA were mixed in a weight ratio of 73.4:8.3:0.9:17.4.

### Test Example 1

In this test example, electrodes were manufactured using the negative electrode slurries prepared by the methods of Example 1 and Comparative Examples 1 and 2, and half-cell evaluation was performed.

To this end, a copper current collector was coated with each negative electrode slurry prepared in Example 1 and Comparative Examples 1 and 2 using an electrode coater and then placed in an oven at a temperature of 100° C. for vacuum drying for 24 hours. When coated with the negative electrode slurry, the loading capacity of the silicon-based active materials per area was set to a level up to 4.1 mAh/cm². Then, after rolling, the coated current collector was punched into a circular electrode having a diameter of 14 mm, which was used as a negative electrode to manufacture a half-cell.

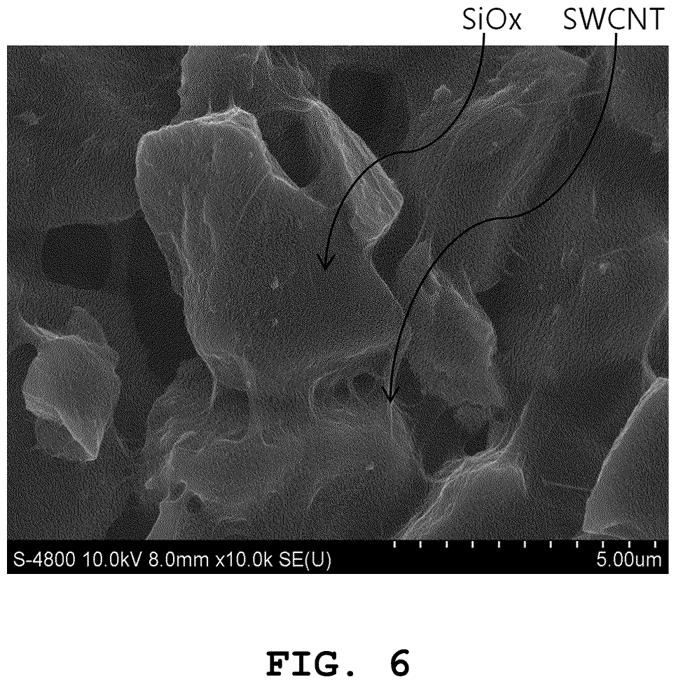

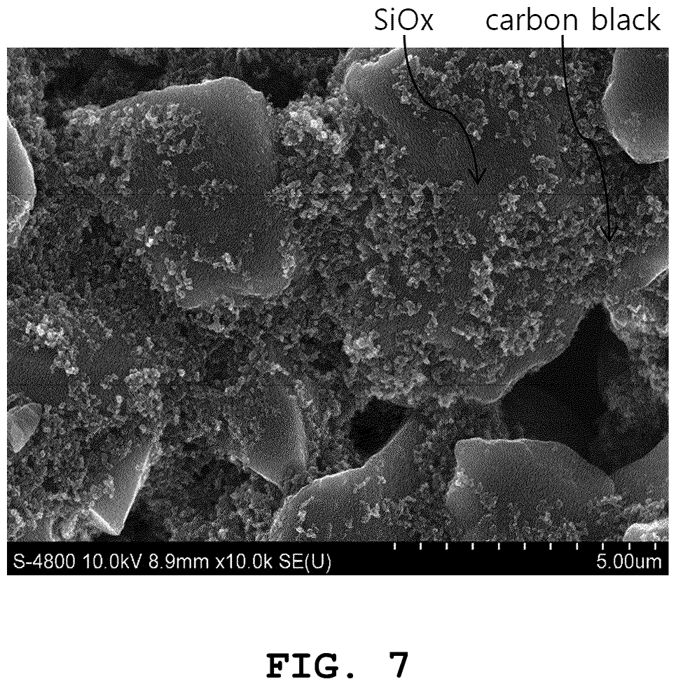

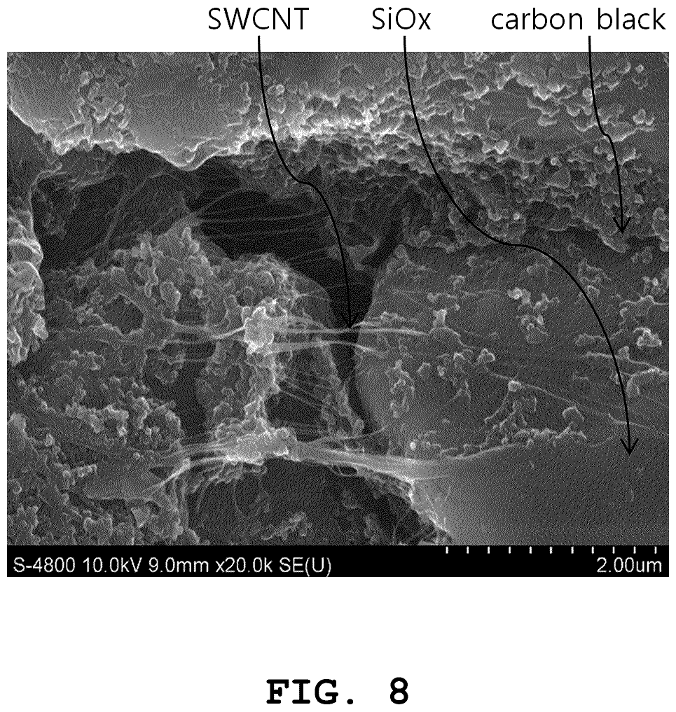

First, the surface of a negative electrode active material layer composed of each negative electrode slurry was examined using SEM images. FIG. 6 is an SEM image examined after coating the copper current collector with the negative electrode slurry according to Example 1, FIG. 7 is an SEM image examined after coating the copper current collector with the negative electrode slurry according to Comparative Example 1, and FIG. 8 is an SEM image examined after coating the copper current collector with the negative electrode slurry according to Comparative Example 2.

Referring to FIG. 6, showing the negative electrode manufactured using 2 wt % of the single-walled carbon nanotubes as the conductive additive alone, the amount of the silicon-based active materials accounts for 80%. While the volume of the silicon-based active materials expands by about 2 to 4 times and then contracts as charging and discharging continue, the single-walled carbon nanotubes connect the silicon-based active materials during the contraction following expansion, enabling the electrical network to be well-maintained.

FIG. 7 shows the negative electrode active material layer composed of carbon black, used as an existing particulate conductive additive, without involving the single-walled carbon nanotubes of the present disclosure. When mixed with the silicon-based active materials, this carbon black becomes attached to the surface of each silicon-based active material, thus forming pores between the silicon-based active materials. For this reason, carbon black fails to connect the silicon-based active materials, whose volume expands and contracts during charging and discharging, causing a problem in that carbon black is eventually detached.

FIG. 8 shows the negative electrode active material layer composed by mixing the single-walled carbon nanotubes prepared in Preparation Example 1 of the present disclosure with carbon black, an existing conductive additive. Even when carbon black is attached to the surface of the silicon-based active materials, the single-walled carbon nanotubes enable the silicon-based active materials to be connected, thereby maintaining the electrical properties.

Subsequently, using the negative electrode, an electrolyte (1.0 M LiPF₆ in EC/EMC ( 3/7 vol %)+VC (1.5)+PS (0.5) wt %), a separator (PE), and a lithium counter electrode, a CR2032-standard coin cell was constructed. After stabilizing the manufactured coin cell at a temperature of 35° C. for 40 hours, 1 cycle of formation (Charge 0.1 C CC, 0.005 C CV, Cut-off (0.005 V) Rest 30 min/Discharge 0.1 C, Cut-off (1.5 V) Rest 30 min) was tested at room temperature. Then, battery life tests for 50 cycles (Charge 0.2 C CC, 0.005 C CV, Cut-off (0.005 V)/Discharge 0.2 C, Cut-off (1.5 V)) were performed at a charge/discharge rate of 0.2 C.

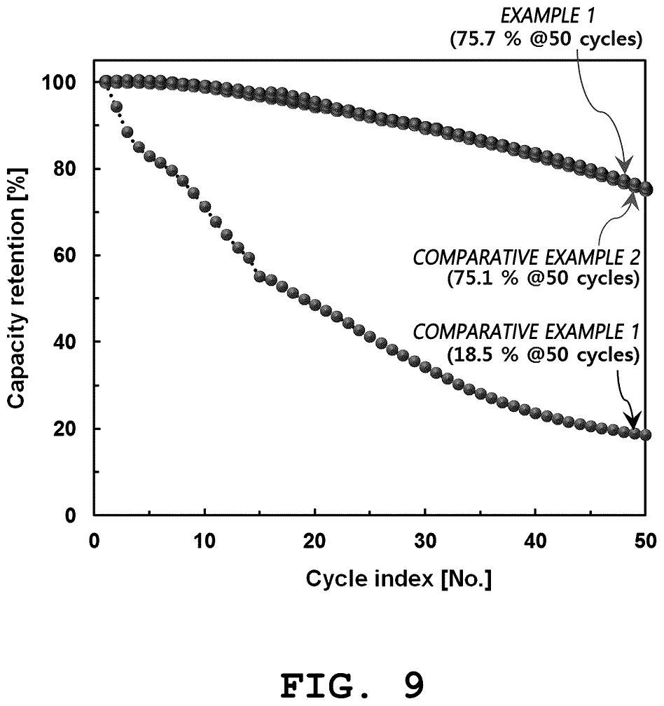

FIG. 9 is a graph showing the capacity retention rate according to the charge/discharge cycles of Example 1 and Comparative Examples 1 and 2. Example 1, in which 2 wt % of the single-walled carbon nanotubes were added alone as a linear conductive additive, showed the best life characteristics with a capacity retention rate of 75.7% at 50 cycles according to the cycle life test. This result may be attributable to improved electrochemical performance during charging and discharging through improved mechanical strength and electrical network by uniform dispersion with the silicon-based active materials when manufacturing the negative electrode using the chemically de-bundled, low-defect single-walled carbon nanotubes.

In the case of Comparative Example 1, as a result of performing the battery life test on the cell after manufacturing the negative electrode using 10 wt % of the general-purpose particulate conductive additive, the capacity was characterized due to by continuously decreasing the deterioration characteristics of the negative electrode, showing that the result of the capacity retention rate at 50 cycles was 18.5%. Through this, it is seen that the capacity retention rate in the case of Example 1 is about 4 times higher than that in the case of Comparative Example 1, confirming that the single-walled carbon nanotubes stably maintain the silicon-based active materials and thus obtain electrical properties.

In the case of Comparative Example 2, the result of the cycle life test performed on the coin cell composed of the negative electrode active material layer having a composition including 0.9 wt % of the single-walled carbon nanotubes, the linear conductive additive of the present disclosure, and 8.3 wt % of carbon black, the existing particulate conductive additive, is shown. In the case of Comparative Example 1, in which the particulate conductive additive was used alone, it was found that pores were formed between the silicon-based active materials, indicating that these pores deteriorated the electron-collection and interfacial diffusion characteristics of electrolyte ions during charging and discharging. On the contrary, when adding the linear conductive additive to the particulate conductive additive and mixing these additives as in Comparative Example 2, the single-walled carbon nanotubes, the linear conductive additive, connect and strongly bind the silicon-based active materials in the pores between the silicon-based active materials. As a result, the electrical network characteristics were further improved compared to that in Comparative Example 1, confirming that a behavior similar to that in Example 1 was observed. This enabled the life characteristics of the cell to be improved, showing that the capacity retention rate at 50 cycles was 75.1%, which was close to that in the case of Example 1.

In summary, the present disclosure is characterized by providing a low-defect highly-conductive carbon nanotube sludge containing carbon nanotubes obtained as follows: mixing carbon nanotubes in a solution containing a first acid and an alkali metal salt, subsequently mixing a second acid therein to expand the volume of the resulting mixture containing the carbon nanotubes, de-bundling the carbon nanotubes through oxidation and detachment by applying shear stress to the high-concentration mixture, and neutralizing and washing the de-bundled carbon nanotubes.

According to such a characteristic, the carbon nanotubes having a small diameter of several nm or smaller are formed to a long length of several hundreds of μm during the synthesis process thereof. Additionally, through the non-destructive wet chemical de-bundling process of the carbon nanotube powders that are strongly aggregated in a flake or particle form with several mm in size due to strong van der Waals attraction resulting from high aspect ratios, oxygen-containing functional groups are formed only at the terminals without causing damage to the inherent sp² structure on the wall of the carbon nanotube, which is the source of high electrical conductivity. Furthermore, crystallinity is excellent while having a length in a range of 3 to 70 μm, so low-defect highly-conductive carbon nanotubes having a high I_{G}/I_{D} ratio in a range of 5 to 50 in the Raman spectrum are provided without involving a separate post-reduction process, which is meaningful.

Accordingly, there may be advantages in that large-scale synthesis of the carbon nanotube sludge is possible, and better electrical, mechanical, and thermal properties are provided with a smaller amount of the carbon nanotubes, making the carbon nanotube sludge applicable not only as a conductive additive for a negative electrode of lithium secondary batteries by including an aqueous binder or as a conductive additive for a positive electrode of lithium secondary batteries by including an organic binder, but also to pure carbon nanotube filament fibers. Furthermore, the carbon nanotube sludge is applicable to various fields such as heat dissipation, shielding, and heat generation that require electrical, thermal, and physical lightweight properties.

In particular, a negative electrode in a lithium secondary battery has been typically composed of silicon-based active materials, a conductive additive, and a binder in a weight ratio of 80:10:10, as in Comparative Example 1. The proportion of the conductive additive has been relatively high because cell performance deteriorates due to problems, including an increase in internal volume caused by the low electrical conductivity of the silicon-based active materials themselves and continuous solid electrolyte interphase (SEI) reactions with an electrolyte, which is the technical difficulty of the silicon-based active materials, particle pulverization caused thereby, and volume expansion.

In order to overcome the difficulty mentioned above, the present disclosure uses the chemically de-bundled, linear, and low-defect carbon nanotubes as a conductive additive to improve the electrical conductivity properties of the silicon-based active materials having low electrical conductivity while improving cell performance by improving mechanical strength and electrical network characteristics through the strong binding of a conductive additive-polymer binder composite material that is highly conductive and applicable in one step during manufacturing negative electrode.

In other words, when using single-walled carbon nanotubes as conductive additives, the internal resistance component of a negative electrode may be reduced by the excellent electrical conductivity properties thereof. However, when preparing a negative electrode slurry, there are problems in that the density of the negative electrode is non-uniform due to difficulties in dispersion and the like, and electrode resistance increases due to the aggregation of silicon-based active materials, conductive additives, and binders. On the contrary, in the present disclosure uses, the chemically de-bundled, low-defect carbon nanotubes are used. Thus, when manufacturing a negative electrode using a negative electrode slurry, dispersion stability, uniform density of the negative electrode, and negative electrode surface characteristics may be exhibited while improving electrochemical cell performance.

The description provided above is disclosed only for illustrative purposes of the technical idea of the present disclosure, and various modifications and variations will be possible to those skilled in the art without departing from the essential characteristics of the present disclosure. Accordingly, the examples disclosed herein are not intended to limit the technical ideas of the present disclosure but are provided for illustrative purposes. The scope of the technical ideas of the present disclosure is not limited by these examples.

The protective scope of the present disclosure should be construed in accordance with the scope of the appended claims, and all technical ideas within the equivalent scope thereof should be construed as falling within the scope of rights of the present disclosure.

1. A low-defect carbon nanotube sludge comprising carbon nanotubes having crystallinity while satisfying Relational Expression 1,
$$5 \leq {I}_{G} / {I}_{D} \leq 50 \qquad [ Relational Expression 1 ]$$
(wherein I_{G}/I_{D} is a value calculated as a ratio of a maximum peak intensity (I_{G}) measured at a wavenumber region of 1,580±50 cm⁻¹ to a maximum peak intensity (I_{D}) measured at a wavenumber region of 1,360±50 cm⁻¹ in a Raman spectrum).

2. The sludge of claim 1, wherein the carbon nanotubes comprise one or more types selected from the group consisting of single-walled carbon nanotubes and double-walled carbon nanotubes.

3. The sludge of claim 1, wherein the carbon nanotubes are obtained by introducing carbon nanotubes into a solution in which an alkali metal salt is dissolved in a first acid, leaving the resulting solution, further introducing a second acid thereinto, applying shear stress to de-bundle the introduced carbon nanotubes, and neutralizing and washing the de-bundled carbon nanotubes.

4. The sludge of claim 3, wherein the first acid comprises one or more selected from the group consisting of sulfuric acid, fuming nitric acid, red fuming nitric acid, and phosphoric acid, and
the second acid comprises one or more selected from the group consisting of nitric acid, hydrogen peroxide, and hydrochloric acid.

5. The sludge of claim 3, wherein the alkali metal salt comprises one or more selected from the group consisting of a nitric acid compound, a sulfuric acid compound, and a phosphoric acid compound that comprise one or more elements among lithium (Li), sodium (Na), potassium (K), rubidium (Rb), and cesium (Cs).

6. The sludge of claim 1, wherein the carbon nanotubes have a length in a range of 3 to 70 μm.

7. A method of preparing a low-defect carbon nanotube sludge, the method comprising:
preparing a mixture by introducing carbon nanotubes into a solution in which an alkali metal salt is dissolved in a first acid and leaving the resulting solution;
de-bundling the carbon nanotubes by introducing a second acid into the prepared mixture and applying shear stress; and
obtaining a carbon nanotubes by neutralizing and washing the resulting mixture comprising the de-bundled carbon nanotubes,
wherein the carbon nanotubes have crystallinity while satisfying Relational Expression 1,
$$5 \leq {I}_{G} / {I}_{D} \leq 50 \qquad [ Relational Expression 1 ]$$
(wherein I_{G}/I_{D} is a value calculated as a ratio of a maximum peak intensity (I_{G}) measured at a wavenumber region of 1,580±50 cm⁻¹ to a maximum peak intensity (I_{D}) measured at a wavenumber region of 1,360±50 cm⁻¹ in a Raman spectrum).

8. The method of claim 7, wherein the carbon nanotubes comprise one or more types selected from the group consisting of single-walled carbon nanotubes and double-walled carbon nanotubes.

9. The method of claim 7, wherein the first acid comprises one or more selected from the group consisting of sulfuric acid, fuming nitric acid, red fuming nitric acid, and phosphoric acid, and
the second acid comprises one or more selected from the group consisting of nitric acid, hydrogen peroxide, and hydrochloric acid.

10. The method of claim 7, wherein the alkali metal salt comprises one or more selected from the group consisting of a nitric acid compound, a sulfuric acid compound, and a phosphoric acid compound that comprise one or more elements among lithium (Li), sodium (Na), potassium (K), rubidium (Rb), and cesium (Cs).

11. A conductive composite material based on low-defect carbon nanotubes, the conductive composite material comprising:
a polymer binder; and
sludge-form carbon nanotubes dispersed in the polymer binder,
wherein the carbon nanotubes are the carbon nanotubes of claim 1.

12. A negative electrode slurry comprising:
a silicon-based active material; and
the conductive composite material of claim 11.

13. A negative electrode comprising a negative electrode active material layer formed by the negative electrode slurry of claim 12.

14. A lithium secondary battery comprising the negative electrode of claim 13.

15. A conductive composite material based on low-defect carbon nanotubes, the conductive composite material comprising:
a polymer binder; and
sludge-form carbon nanotubes dispersed in the polymer binder,
wherein the carbon nanotubes are the carbon nanotubes of claim 2.

16. A conductive composite material based on low-defect carbon nanotubes, the conductive composite material comprising:
a polymer binder; and
sludge-form carbon nanotubes dispersed in the polymer binder,
wherein the carbon nanotubes are the carbon nanotubes of claim 3.

17. A conductive composite material based on low-defect carbon nanotubes, the conductive composite material comprising:
a polymer binder; and
sludge-form carbon nanotubes dispersed in the polymer binder,
wherein the carbon nanotubes are the carbon nanotubes of claim 4.

18. A conductive composite material based on low-defect carbon nanotubes, the conductive composite material comprising:
a polymer binder; and
sludge-form carbon nanotubes dispersed in the polymer binder,
wherein the carbon nanotubes are the carbon nanotubes of claim 5.

19. A conductive composite material based on low-defect carbon nanotubes, the conductive composite material comprising:
a polymer binder; and
sludge-form carbon nanotubes dispersed in the polymer binder,
wherein the carbon nanotubes are the carbon nanotubes of claim 6.
